(19) United States
(12) Patent Application Publication
(10) Pub. No.: US 2009/0213700 A1
(43) Pub. Date: Aug. 27, 2009

(54) Automated Interval Timing Method Devices and System

(76) Inventor: James R. Conant, Brookfield, CT (US)

Correspondence Address: OUR PAL ASIJA;ASIJA HOUSE, 7 WOONSOCKET AVENUE, SHELTON, CT, 06484-5536, US

(21) Appl. No.: 12/389,604

(22) Filed: Feb. 20, 2009

Related U.S. Application Data
(60) Provisional application No. 61/067,135, filed on Feb. 27, 2008.

(51) Int. Cl. G04F 10/00

(52) U.S. Cl. 368/113

(57) ABSTRACT

Automated Interval Timing Method Devices and System for automatically timing a plurality of moving entities over a course with predetermined finish line are delineated. Each moving entity wears, carries or has mounted on it a timing unit which is actuated by an acoustic starting signal. A device is located at the finish line so as to create an acoustic field that is narrow in the direction of travel of the moving entities. As each moving entity crosses the finish line, the timing unit detects the finish line acoustic field and records and displays the elapsed time from the acoustic starting signal to the crossing of the finish line. More particularly the timing system comprises wearable or mountable stopwatches, and an array of narrow-beam acoustic transmitters located at the finish line. Each participant or vehicle in a race wears or carries a stopwatch. Each stopwatch is started by the sound of a starting pistol or an electronically generated starting tone or other distinctive acoustic starting signal. Split times and finish times are recorded by the stopwatch when it recognizes the finish line acoustic signal.

### RELATED DOCUMENTS

This application is substantially the same as provisional application Ser. No. 61/067,135 filed Feb. 27, 2008 by the same inventor-applicant then entitled, “Acoustically Triggered Timing System” and the applicant hereby claims priority there from.

### BACKGROUND

This invention relates generally to timing of track events in a track and field competition which can be done manually or automatically. Manual timing of track competition events requires a person to start a timing device (such as a stopwatch) at the starting gunshot, and to stop the timing device when the athlete crosses the finish line. For shorter races, one timing official per athlete or lane is needed. Manual timing is inexpensive and easy to use, but inaccurate (worse than 0.1 second accuracy) and subject to confusion regarding finish order in close races.

There are several different kinds of systems available for automatic timing of track competitions. Typically these systems use electronic devices attached to or in proximity of starter pistols to initiate timing. Other systems use optical detectors in conjunction with specially formulated blank gun cartridges to capture the muzzle flash at a distance from the starter pistol. Video capture, inductive tags, and Radio-Frequency Identification (RFID) tags are methods used to record the time of an athlete crossing the finish line. These systems are more accurate (typically 0.02 to 0.001 second accuracy) than manual timing, but are expensive and are complicated and time-consuming to set up and use.

### The Problem

The problem with prior art timing devices is that they are not fully automatic, accurate, easy to use, or affordable.

Another problem with prior art methods, devices and systems is that they are not suitable for use in adverse or otherwise challenging conditions

The problems with prior art timing devices can be summarized into following categories.
1. Not fully automatic so that human judgment is always required (all timing systems)
2. Not accurate (manual timing)
3. Not easy to use (automatic timing systems)
4. Not affordable (automatic timing systems)

This invention solves these problems and more in a simple, aesthetic and elegant manner.

### SUMMARY

This invention enables an automatic method of timing which is sufficiently accurate (0.01 seconds accuracy or better) for most track and field competitions, is easy to setup and use, and is affordable. The invention comprises a wearable timing device and a means for producing a narrow trigger beam at the track finish line.

### PRIOR ART

A prior art patentability and novelty search was conducted by the inventor.

The closest prior art known to the applicant and/or his attorney is as follows arranged in the chronological order.
a) U.S. Pat. No. 3,596,103 issued on 27 Jul. 1971 to Matthews, et al. for “Multiple Timing Apparatus for Track Events and the Like”
b) U.S. Pat. No. 3,631,453 issued on 28 Dec. 1971 to Stalp et al for “Timer Start-Stop Apparatus”
c) U.S. Pat. No. 4,571,698 granted on Feb. 18, 1986 to Armstrong for “Apparatus and System for Remote Timing of Plural Entities”
d) U.S. Pat. No. 4,752,764 awarded on 21 Jun. 1988 to Peterson, et al. for “Electronic Timing and Recording Apparatus”
e) U.S. Pat. No. 5,194,861 bestowed on Mar. 16, 1993 to St. Clair for “On-Board Timer System for a Racing Vehicle”
f) U.S. Pat. No. 5,245,162 earned on 14 Sep. 1993 by Takahashi for “Method for Determining Sequence of Arrival and a Racing Time of Runners at Finish Line by Use of Bar Codes”
g) U.S. Pat. No. 5,293,354 rewarded on 8 Mar. 1994 to Costabile for “Remotely Actuate-able Sports Timing System”
h) U.S. Pat. No. 5,436,611 published on 25 Jul. 1995 in the name of Inventor Arlinghaus, Jr. for “Race Recording and Display System”
i) U.S. Pat. No. 5,511,045 issued on 23 Apr. 1996 to Sasaki, et al. for “Time Measurement Apparatus and System Having Reception or Transmission Function”
j) U.S. Pat. No. 5,737,280 honorably given on 7 Apr. 1998 to Kokubo for “Clocking System for Measuring Running Speeds of Track Runners”
k) U.S. Pat. No. 6,072,751 granted on 6 Jun. 2000 to Kirson, et al. for “Athletic Training Device and Method”
l) U.S. Pat. No. 6,669,600 bestowed on 30 Dec. 2003 on Inventor Warner for “Computerized Repetitive—Motion Exercise Logger and Guide System”
m) U.S. Pat. No. 7,057,975 blessed on 6 Jun. 2006 on Inventor Stobbe for inventing “Method and Device for Automatic Timing in Mass Sporting Events”

### DISCUSSION OF THE PRIOR ART

The closest prior art is the U.S. Pat. No. 4,571,698 which teaches an apparatus and system for timing of plural entities, typically runners in a marathon race. The starting of the timing device carried on each runner is determined by an airborne signal only when the runner is within a predetermined limited distance of the starting signal transmitter (i.e. a starting gate). This apparatus is not applicable to track competitions where the starting signal is an acoustic signal designating a start time and the runners can be various distances (staggered start) from the starting signal at the start of a track competition event. Accordingly none of the prior art devices singly or even in combination provides all of the features and objectives established by the inventor for this system as enumerated below.

### Objectives

1. It is an objective of this invention to provide methods, devices and system to provide precision interval timing.
2. An objective of this invention is to enable an automatic method of timing an interval of travel time from start to finish line which is sufficiently accurate (0.01 seconds accuracy or better) for most track and field competitions.
3. Another objective of this invention is that it is easy to setup and use, and is affordable.
4. Another objective of this invention is that the device of this invention be a wearable timing device so as to eliminate confusion about which measured time interval belongs to which competitor.
5. Another objective of this invention is to incorporate a means for producing a narrow trigger beam at the track finish line.
6. Another objective of this invention is that it improves functionality without confusing the user.
7. Another objective of this invention is to accommodate applications where smaller size is a requirement
8. Another objective of this invention is to provide multiple modes of operation.
9. Another objective of this invention is that it is easy to use and requires little training.
10. Another objective of this invention is that it be environmentally friendly.
11. Another objective of this invention is that it meets all federal, state, local and other private standards, guidelines and recommendations with respect to safety, environment, and quality and energy consumption.
12. Another objective of this invention is that it be elegantly simple in concept and design.
13. Another objective of this invention is that it be easy to assemble, service, transport, set-up, unpack and store.
14. Another objective of this invention is that it be useable in all types of locations including home, schools, work and play sites.
15. Another objective of this invention is that the timing system and the underlying concept can be adapted and or reconfigured for other uses.
16. Another objective of this invention is that it lends itself to multiple uses.
17. Another objective of this invention is that it be reliable such that it practically never fails and requires little or no maintenance.
18. Another objective of this invention is that the timing device can be triggered in a variety of ways manually (for example acoustically) as well as electronically (for example via transmitted and received radio signal.
19. Another objective of this invention is to use an array of ultrasound transducers cooperatively in a non-interfering manner.
20. Another objective of this invention is that it accommodates a plurality of moving entities such as athletes, bicycle races and car races.

Other objectives of this invention reside in its simplicity, elegance of design, ease of manufacture, service and use as will become apparent from the following brief description of the drawings and the detailed description of the concept embodiment.

### BRIEF DESCRIPTION OF THE DRAWINGS

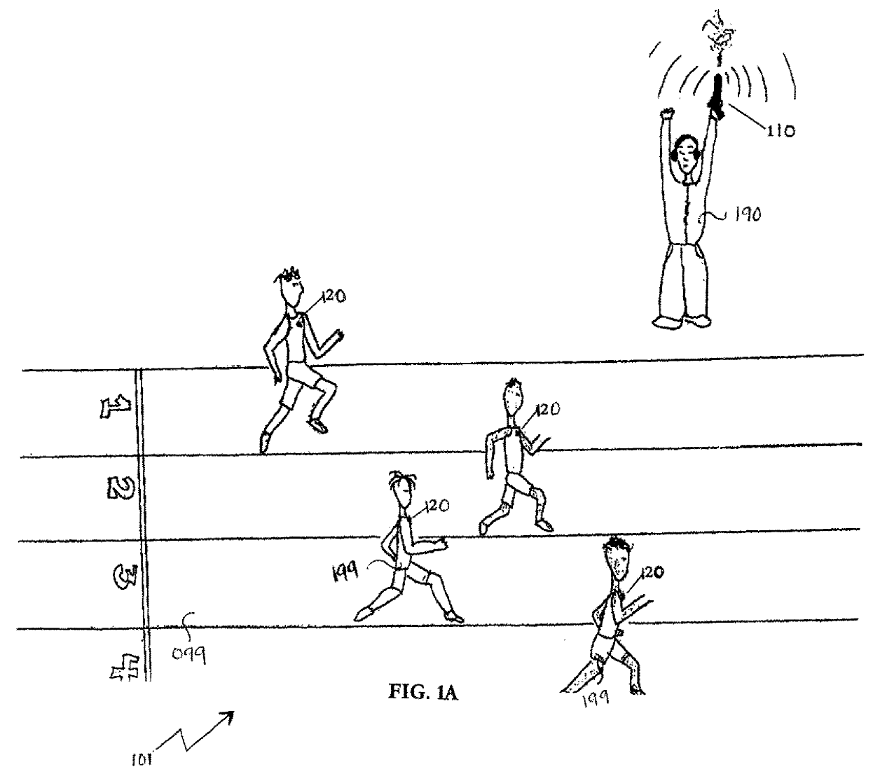

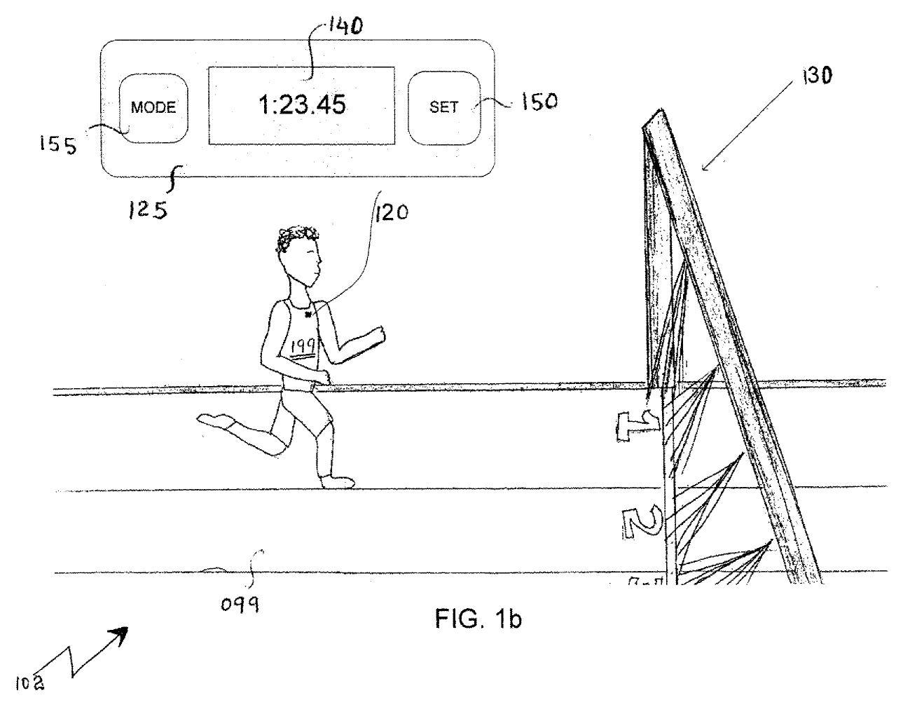

a) FIG. 1A is an overview of the invention showing the start of a track meet running event in which the invention would be used.

b) FIG. 1B is an overview of the invention showing the finish of a track meet running event in which the invention would be used.

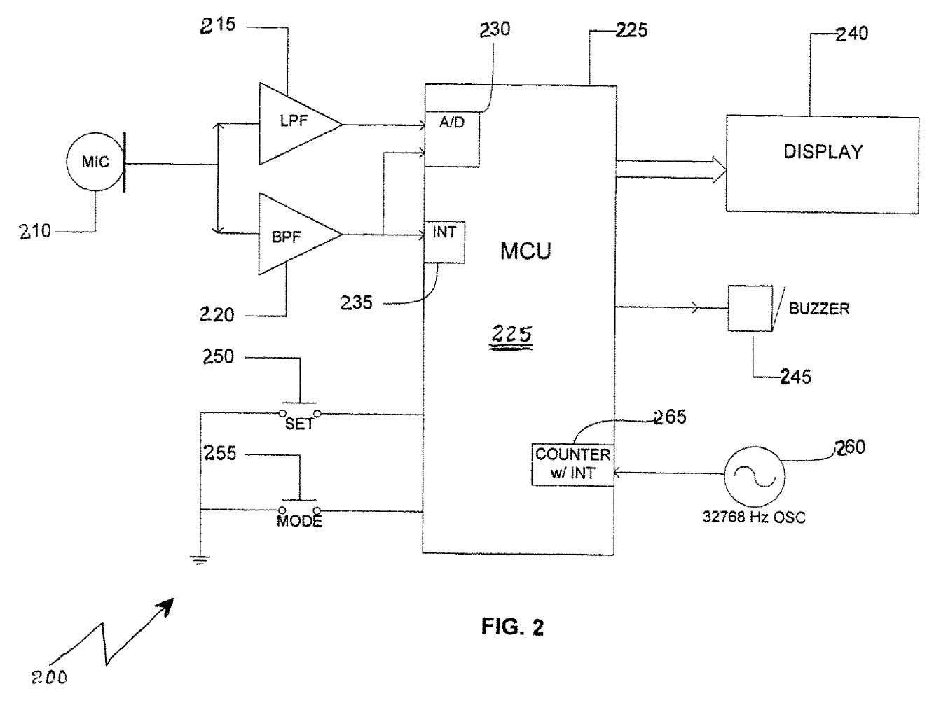

c) FIG. 2 is a block diagram of the wearable timing device.

### DETAILED DESCRIPTION OF THE BEST MODE PREFERRED EMBODIMENT

The Automated Interval Timing Method Devices and System of this invention as shown in the drawings wherein like numerals represent like parts throughout the several views. FIG. 1A is a an overview of the invention showing the start of a track meet running event in which the invention would be used complete with plurality of running lanes 099, trigger instrumentality or equivalent means 110, wearable electronic timing device 120, Trigger Operator 190 and runners 199.

FIG. 1B is an overview of the invention showing the finish of a track meet running event in which the invention would be used complete with running lanes 099, trigger instrumentality or equivalent means 110, wearable electronic timing device 120, Trigger Operator 190 and runners, Timing Device or module MCU 125, Finish line 130, Display 140, Set switch 150, Mode Switch 155, Trigger Operator 190 and plurality of Runner(s) 199

FIG. 2 is a block diagram of the wearable timing device complete with Microphone 210, Low Pass Filter 215, Band Pass Filter 220, Microprocessor Control Unit, A/D (Analog to Digital) Converter 230, Display unit 240, Buzzer 245, Set switch 250, Mode switch 255, Signal Generator 260, and Counter with Interrupt 265.

The preferred embodiment of the invention comprises the following modules:
a) A wearable timing device
b) A start trigger means
c) A finish line trigger means

An embodiment of the wearable timing device recognizes an acoustic start signal (typically the blast of a starting pistol) and an acoustic finish line signal. The acoustic finish line signal is provided by an overhead or underfoot array of ultrasonic transducers. Timing is started when the timing device recognizes the start signal. After the start signal, the timing device listens for acoustic energy of the ultrasonic frequency used for the finish line signal. The time of the peak ultrasonic energy and/or the time of the first nulls on both sides of the main lobe are used to record the time of crossing the finish line, which can be used as a split time or a finish time. The last time of crossing the finish line is displayed on the wearable timing device. Split or interval times can be called up for display by pressing a switch on the wearable timing device.

Additionally, the wearable timing device has means and methods for transmitting timing information to a computer or other device used for collecting and displaying track meet event results.

The wearable timing device 120, 225 is typically worn on the shoulder strap of the jersey of an athlete so that the time of the torso crossing the finish line can be recorded. It could also be attached to or embedded in a baton for a relay race. For a race involving vehicles (such a bicycles), it could be attached to the vehicle.

In another aspect, the wearable timing device recognizes a variety of acoustic start signals (e.g. whistle, electronic tone, air horn, etc.) so that the invention can be used in other applications where automatic timing is required. In particular, use of the system in track practices would be enabled by recognition of a whistle as an acoustic start signal.

As the use of RF electronics is becoming widespread due to integration, miniaturization and concomitant cost reduction, it is anticipated that at some point in the near future an RF signal could be used as a starting signal for the wearable timing device. For track meets, the RF signal would be generated by an additional means coupled to the starting pistol. The wearable timing device would incorporate a small antenna and RF starting signal detection means.

FIGS. 1-A and 1-B illustrate an embodiment of the timing system according to the invention. An acoustic signal generator 110 is provided for starting a plurality of wearable timing devices 120 by means of a distinctive acoustic signal, typically the blast of a starter pistol. Other acoustic signals such as those generated by a whistle, an air horn, or a loudspeaker can be employed for starting the wearable timing devices. Once the timing device has started timing upon being actuated by the signal from the acoustic signal generator 110, it measures elapsed time up until it receives an ultrasonic acoustic signal from an array of ultrasonic transmitters 130 present at the finish line.

FIG. 2 shows a functional block diagram of the wearable timing device 200. A microphone 210 converts audible and ultrasonic acoustic energy into an electrical signal. The output of the microphone 210 is filtered and amplified by low-pass filter 215 and band-pass filter 220. An alternative embodiment would have a microphone for detecting the blast of the starter pistol and other low-frequency (audible) starting sounds, and a separate microphone for detecting the ultrasonic signal.

The wearable timing device is placed in an ARMED state by holding the SET pushbutton switch 250 closed for a predetermined length of time on the order of several seconds. While in the ARMED state the wearable timing device is ‘listening’ for an acoustic signal signifying the start of the race. More specifically, in the ARMED state the output of the low-pass filter 215 is sampled by the A/D converter 230 (part of the microcontroller 225 and processed by the microcontroller 225 for detection of the blast of the starter pistol. The low-pass filter 215 suppresses frequencies higher than 10 KHz so that detection of the starting pistol blast can be accomplished without concern for false alarms caused by aliased higher frequency energy. This same arrangement is utilized to detect other kinds of starting signals (whistle, air horn, electronic tone, etc.) by providing different start signal detection criteria in the MCU 225 coupled with possibly different LPF cutoff frequencies and A/D sampling rates.

After detection of the starting pistol blast, the wearable timing device enters the TIMING state where the MCU 225 enables a timer interrupt 265 and then goes into sleep or reduced clock rate mode in order to conserve power. The counter interrupt 265 wakes up the MCU 225 after counting a predetermined number of cycles from the high-accuracy 32768 Hz oscillator 260. Elapsed time is kept by the MCU 225 counting timer interrupts, converting the result into minutes, seconds, and fractional seconds, and displaying the elapsed time on the liquid crystal display (LCD) 240. After updating the LCD 240 the MCU 225 returns to sleep or reduced clock rate mode.

When the wearable timing device 120 crosses the finish line, the microphone 210 picks up the signal from the ultrasonic transmitters 130. In the preferred embodiment, the ultrasonic transmitters are suspended in a linear array approximately 8 feet above the finish line. Typically there are 3 transmitters per track lane 99 to ensure that the full width of the lane is subject to the ultrasound energy. In order to prevent spatial areas of constant destructive interference, adjacent transmitters are driven with slightly different frequencies.

In the preferred embodiment the ultrasonic transmitters 130 transmit in the neighborhood of 40 KHz so as to provide a fairly narrow beam using a small aperture transducer. The ultrasonic frequency has the further advantage of being in a quieter region of the acoustic spectrum where spurious acoustic energy is unlikely to trigger a false alarm.

In the wearable timing device 120, the high-Q band pass filter 220 will pass and amplify the ultrasonic frequency signal causing an interrupt 235 on the MCU 225. The MCU will awake from sleep mode and begin sampling the output of the BPF 220 with the A/D converter 230 and storing the sample data in a memory buffer. Once the memory buffer is filled, the MCU 225 will determine the time of peak signal energy from the A/D samples and define that to be the time of crossing the finish line. If the wearable timing device crosses the finish line slowly so that multiple peaks are detected, then the times of the −3 db down points before and after the finish line can be interpolated to select the correct peak energy time. The most-recent finish-line crossing time may also be displayed alternately with the elapsed time, which continues to increment.

After the athlete has crossed the finish line for the last time (in longer races the finish line 130 may be crossed multiple times), the athlete or timing official presses the SET pushbutton switch 150 to end the timing. The wearable timing device is now in the FINISHED state. The MCU 225 will recognize the switch closure and write the last finish line time to the display 240.

The athlete can view prior finish line crossing times (commonly referred to as “split” times) by pressing the SET switch 150, 250 repeatedly. Software in the MCU 225 will respond to the repeated SET switch 150 closures by retrieving the split times from memory and displaying them.

Also shown in FIG. 2 is a buzzer 245. This buzzer is driven by the MCU 225 and is used to provide audible confirmation of certain events to the user. For example, the buzzer is actuated when a starting signal has been detected and when a finish line crossing is detected. Additionally, the buzzer 245 and microphone 210 provide an acoustic communication means for the MCU 225 to communicate with a personal computer for uploading of timing data, or downloading of configuration data. Furthermore, a remote control device can use this acoustic communication means to control the wearable timing device (e.g. a timing official uses a remote control to place one or more wearable timing devices in a specific state such as ARMED or FINISHED).

Also shown in FIG. 2 is a MODE pushbutton switch 255. Actuation of this switch in conjunction with actuation of the SET pushbutton switch 250, 150 software in the MCU 225, and display of options and parameters on the display 240 allows the user of the wearable timing device to configure it for different scenarios. For instance, the wearable timing device can be configured to recognize different start signals such as a whistle, electronic tone, air-horn, or any loud sound. As another example the wearable timing device can be configured as a manual stopwatch by recognizing only closures of the SET switch 150, 250 to start and stop timing, or as a semi-automatic stopwatch where only the start or only the stop is determined by closure of the SET switch 150.

### Assembly Use and Operation

The assembly, set-up, use and dismantling of Automated Interval Timing Method Devices and the System is very simple, elegant and even intuitive. Nonetheless the applicant suggests the following steps as guidelines.
a) donning a wearable timing device on each said moving entity;
b) donning a wearable timing device on each said moving entity; arming said timer in state ready to receive a START signal;
c) starting each said timer upon receipt of said START signal;
d) recording the elapsed time of an acoustic signal present at the finish line; and
e) calculating displaying and communicating time intervals based on recorded finish line crossing times.

The inventor has given a non-limiting description of this invention. Due to the simplicity and elegance of the design of this invention designing around it is very difficult if not impossible. The concept of the keypad disclosed here would be difficult to design around. Nonetheless many changes may be made to this design without deviating from the spirit of this invention. Examples of such contemplated variations include the following:

1. The value and the tolerance of various electronic components may be modified.

2. Different enclosures for the wearable device to enable easy mounting to other moving entities.

3. Manual trigger may be replaced by au automated trigger.

4. A different electronic or acoustic trigger means may be employed.

5. Additional complimentary and complementary functions and features may be added.

6. A more economical or an upscale version of the device may be adapted.

Other changes such as aesthetics and substitution of newer materials as they become available, which substantially perform the same function in substantially the same manner with substantially the same result without deviating from the spirit of the invention may be made.

### REFERENCE NUMBER CONCORDANCE

Following is a listing of the components uses in this embodiment arranged in ascending order of the reference numerals for ready reference of the reader.

099=Running lanes

100=Embodiment of FIG. 1 generally

101=Embodiment of FIG. 1-A

102=Embodiment of FIG. 1-B

110=trigger instrumentality or equivalent means

120=Wearable electronic timing device

125=Timing Device or module MCU

130=Finish line

140=Display

150=Set switch

155=Mode Switch

190=Trigger Operator

199=Runner(s)

200=Embodiment of FIG. 2 generally

210=Microphone

215=Low Pass Filter

220=Band Pass Filter

225=Microprocessor Control Unit

230=A/D (Analog to Digital) Converter

240=Display unit

245=Buzzer

250=Set switch

255=Mode switch

260=Signal Generator

265=Counter with Interrupt

### Definitions and Acronyms

A great care has been taken to use words with their conventional dictionary definitions. Following definitions are included here for clarification.

A/D=Analog to Digital Converter

ARMED (SET)=Timing Device awaiting START signal

BPF=Band Pass Filter

BUZZER=Audible signal

CPU=Central Processing Unit

Hz=Hertz (Cycles/Second)

I/O=Input and Output

INT=Interrupt signal

Interval=Elapsed time from starting signal to finish line

LCD=Liquid Crystal Display

LED=Light Emitting Diode

LPF=Low Pass Filter

MCU=Microprocessor Control Unit

MIC=Microphone

PC=Personal Computer (Standard IBM Compatible)

RFID=Radio Frequency Identification

SET (ARMED)=Timing Device awaiting START signal

While this invention has been described with reference to illustrative embodiments, this description is not intended to be construed in a limiting sense. Various modifications and combinations of the illustrative embodiments as well as other embodiments of the invention will be apparent to a person of average skill in the art upon reference to this description. It is therefore contemplated that the appended claim(s) cover any such modifications, embodiments as fall within the true scope of this invention.

The inventor claims:

1. An automated interval timing system for automatically measuring event intervals of a plurality of moving entities comprising a wearable triggerable timer donned on each of said plurality of moving entities.

2. The automated interval timing system for automatically measuring event intervals of a plurality of moving entities of claim 1 wherein said timer is triggered by a START signal and a STOP signal at the FINISH line.

3. The automated interval timing system for automatically measuring event intervals of a plurality of moving entities of claim 2 wherein said START signal is acoustic.

4. The automated interval timing system for automatically measuring event intervals of a plurality of moving entities of claim 2 which comprises a means at said finish line for producing an acoustic field that is narrow in the direction of travel of said moving entities.

5. The automated interval timing system for automatically measuring event intervals of a plurality of moving entities of claim 2 wherein said START and STOP signals are electronic.

6. The automated interval timing system for automatically measuring event intervals of a plurality of moving entities of claim 5 wherein said wearable triggerable timer is triggered by a START radio-frequency signal.

7. The automated interval timing system for automatically measuring event intervals of a plurality of moving entities of claim 6 comprises a means to prevent spatial areas of constant destructive interference.

8. The automated interval timing system for automatically measuring event intervals of a plurality of moving entities of claim 7 wherein said means to prevent spatial areas of constant destructive interference comprises assignment of slightly different frequencies to adjacent transmitters.

9. The automated interval timing system for automatically measuring event intervals of a plurality of moving entities of claim 2 wherein said START signal is acoustically triggered and radio frequency signal coupled to each wearable timer.

10. The automated interval timing system for automatically measuring event intervals of a plurality of moving entities of claim 9 wherein said wearable triggerable timer comprises a means for receiving and detecting said radio frequency signal.

11. The process of automated interval timing for automatically measuring event intervals of a plurality of moving entities comprising the steps of:
a) donning a wearable timing device on each said moving entity;
b) arming said timer in state ready to receive a START signal;
c) starting each said timer upon receipt of said START signal;
d) recording the elapsed time of an acoustic signal present at the finish line; and
e) calculating, displaying and communicating time intervals based on recorded finish line crossing times.

12. The process of automated interval timing for automatically measuring event intervals of a plurality of moving entities of claim 11 wherein said timer is triggered by a START signal and a STOP signal at the FINISH line.

13. The process of automated interval timing for automatically measuring event intervals of a plurality of moving entities of claim 12 wherein said START signal is acoustic.

14. The process of automated interval timing for automatically measuring event intervals of a plurality of moving entities of claim 12 which comprises a means at said finish line for producing an acoustic field that is narrow in the direction of travel of said moving entities.

15. The process of automated interval timing for automatically measuring event intervals of a plurality of moving entities of claim 12 wherein said START and STOP signals are electronic.

16. The process of automated interval timing for automatically measuring event intervals of a plurality of moving entities of claim 15 wherein said wearable triggerable timer is triggered by a START radio-frequency signals.

17. The process of automated interval timing for automatically measuring event intervals of a plurality of moving entities of claim 16 comprises a means to prevent spatial areas of constant destructive interference. (Note to Pal: “process of automated interval timing” should be in claims 17 thru 20?)

18. The process of automated interval timing for automatically measuring event intervals of a plurality of moving entities of claim 17 wherein said means to prevent spatial areas of constant destructive interference comprises assignment of slightly different frequencies to adjacent transmitters.

19. The process of automated interval timing for automatically measuring event intervals of a plurality of moving entities of claim 12 wherein said START signal is acoustically triggered and radio frequency signal coupled to each wearable timer.

20. The process of automated interval timing system for automatically measuring event intervals of a plurality of moving entities of claim 19 wherein said wearable triggerable timer comprises a means for receiving and detecting said radio frequency signal.
